(19) United States
(12) Patent Application Publication
(10) Pub. No.: US 2007/0070905 A1
(43) Pub. Date: Mar. 29, 2007

(54) Adaptive bin-packing for wireless communications

(76) Inventors: Neal Oliver, Florham Park, NJ (US); Henry Mitchel, Wayne, NJ (US)

Correspondence Address: INTEL CORPORATION;C/O INTELLEVATE, LLC, P.O. BOX 52050, MINNEAPOLIS, MN, 55402, US

(21) Appl. No.: 11/236,382

(22) Filed: Sep. 26, 2005

(51) Int. Cl. H04J 1/16; H04L 12/56

(52) U.S. Cl. 370/235; 370/412

(57) ABSTRACT

Methods and systems for communicating in a wireless network include determining an average size (M) of packets allocated for a particular subscriber station in an air frame, and adjusting a size of packets for that particular subscriber station to be packed into one or more subsequent air frames to be substantially equal to size M. The method may further include arranging incoming data segments and fragmenting one or more of the incoming data segments into the packets of approximately size M. In one implementation, the incoming data segments may be media access controller (MAC) service data units (SDUs) and the packets may be MAC protocol data units (PDUs). Various specific embodiments and variations are also disclosed.

### BACKGROUND OF THE INVENTION

Due to the increasing uses for broadband communications, it is becoming more important to be able to provide high speed telecommunication services to subscribers which are relatively inexpensive as compared to existing cable and land line technologies. As a result, there has been much focus on using wireless mediums for broadband communications. It is an ongoing effort to improve efficiency and/or capacity for high bandwidth wireless communications.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a diagram showing a conceptual layout of an Orthogonal Frequency Division Multiplexing (OFDM) air frame according to various embodiments;

FIG. 3 is a diagram showing a conceptual layout of an Orthogonal Frequency Division Multiple Access (OFDMA) air frame according to various embodiments;

FIG. 4 is a flow diagram showing a process for optimizing placement of data in an airframe according to one embodiment of the present invention; and

FIG. 5 is a block diagram of an example embodiment for an apparatus adapted to perform one or more of the methods of the present invention.

### DETAILED DESCRIPTION OF THE INVENTION

While the following detailed description may describe example embodiments of the present invention in relation to wireless networks utilizing Orthogonal Frequency Division Multiplexing (OFDM) or Orthogonal Frequency Division Multiple Access (OFDMA) modulation, the embodiments of present invention are not limited thereto and, for example, can be implemented using other modulation and/or coding schemes where suitably applicable. Further, while example embodiments are described herein in relation to wireless metropolitan area networks (WMANs), the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs).

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, mobile stations, base stations, access points (APs), gateways, bridges, hubs and cellular radiotelephones. Further, the radio systems within the scope of the invention may include cellular radiotelephone systems, satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

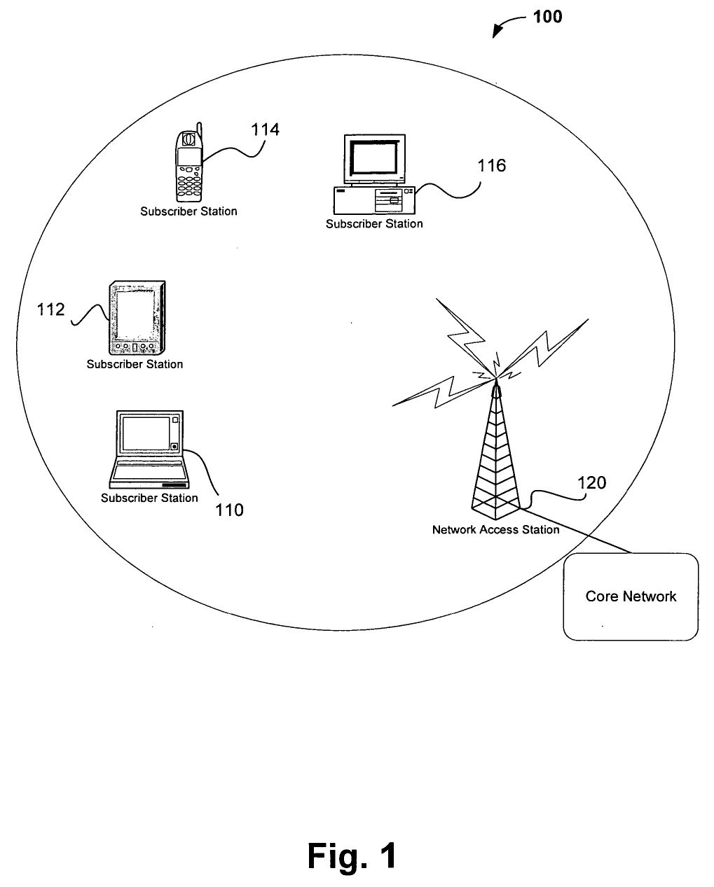

Turning to FIG. 1, a wireless communication system 100 according to one embodiment of the invention may include one or more user stations 110, 112, 114, 116 (also referred to as subscriber stations) and one or more network access stations 120 (also generically referred to as base stations). System 100 may be any type of wireless network such as a WMAN or WWAN where subscriber stations 110-116 communicate with network access station 120 via an over-the-air (OTA) interface.

System 100 may further include one or more other wired or additional wireless network devices as desired. In certain embodiments system 100 may communicate via an air interface utilizing multi-carrier modulation such as a using OFDM and/or OFDMA. OFDM works by dividing up a wideband channel into a larger number of sub-channels. By placing a subcarrier in each sub-channel, each subcarrier may be modulated separately depending on the signal interference to noise ratio (SINR) characteristics in that particular narrow portion of the band. In operation, transmission may occur over a radio channel which may be divided into intervals of uniform, or potentially non-uniform, duration called frames. There are many different physical layer protocols which may be used to encode data into frames. The modulation schemes used may be encoded in a data structure called a burst profile which may be transmitted by the base station 120 to subscriber stations 110-116 and used to determine how to decode data from the physical frame.

A channel may carry multiple service flows of data to and from base station 120 and subscriber stations 110-116. In certain embodiments, each service flow may include, for example, connection identification (CID), quality of service (QoS) class, and/or other flow specific parameters. In the downlink (i.e., from base station to subscriber stations), base station 120 may transmit both data from the service flows and/or control messages. In various embodiments, the base station 120 may also transmit a downlink map and/or an uplink map. The downlink map may describe to the subscriber stations 110-116 the data regions where their data may be found in the downlink subframe (described below), and what burst profile should be used to decode it. The uplink map may describe to the subscriber stations the bandwidth and location in the uplink subframe that has been reserved for their uplink transmissions in the frame.

In the uplink (i.e. from subscriber station to base station), the subscriber stations 110-116 may transmit information in the data regions of the uplink subframe as specified, for example, in an uplink map received from the base station. This information may include data from service flows and control messages, including additional bandwidth requests.

Base station 120 may include a frame assembler responsible for selecting the packets to be coded into a data region, and a scheduler responsible for selecting the order in which packets from different service flows are to be selected for frame assembly. As used herein, the term “packet” may mean protocol data units (PDUs), fragmented service data units (SDUs) or other generic segments of data. Thus the base station may manage queues of service flow data from higher level protocol layers (e.g., internet protocol (IP)) and queues of bandwidth requests received from subscriber stations, construct the uplink and downlink maps if desired, and assemble an air frame data structure which may be subsequently encoded by the physical layer.

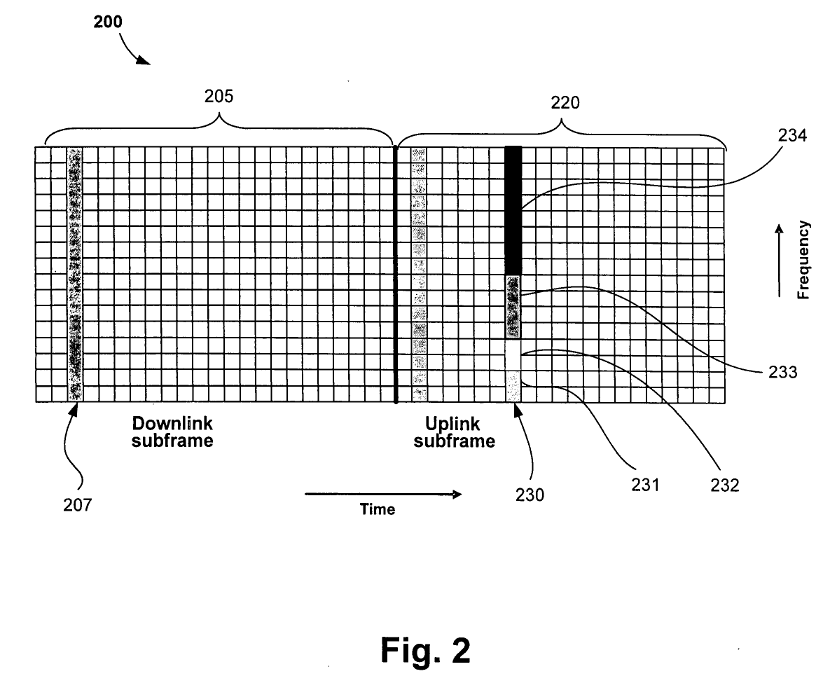

In the example embodiment of FIG. 2 using OFDM, the physical frame 200 may be divided into a time sequence of OFDM symbols. Each symbol may be composed of a collection of modulation symbols multiplexed in frequency (e.g., using quaternary phase shift keying (QPSK), 16-bit or 64-bit quadrature amplitude modulation (QAM)), into which data are encoded.

There may be constraints on how data can be allocated in a frame. For example, using OFDM, in the downlink (e.g., subframe 205), a single OFDM symbol 207 can contain only packets (e.g., media access controller (MAC) PDUs) destined for a common subscriber station. In the uplink, e.g., subframe 220, an OFDM symbol 230 may be divided into various subchannels 231, 232, 233, 234 which again may contain data only from a single subscriber station.

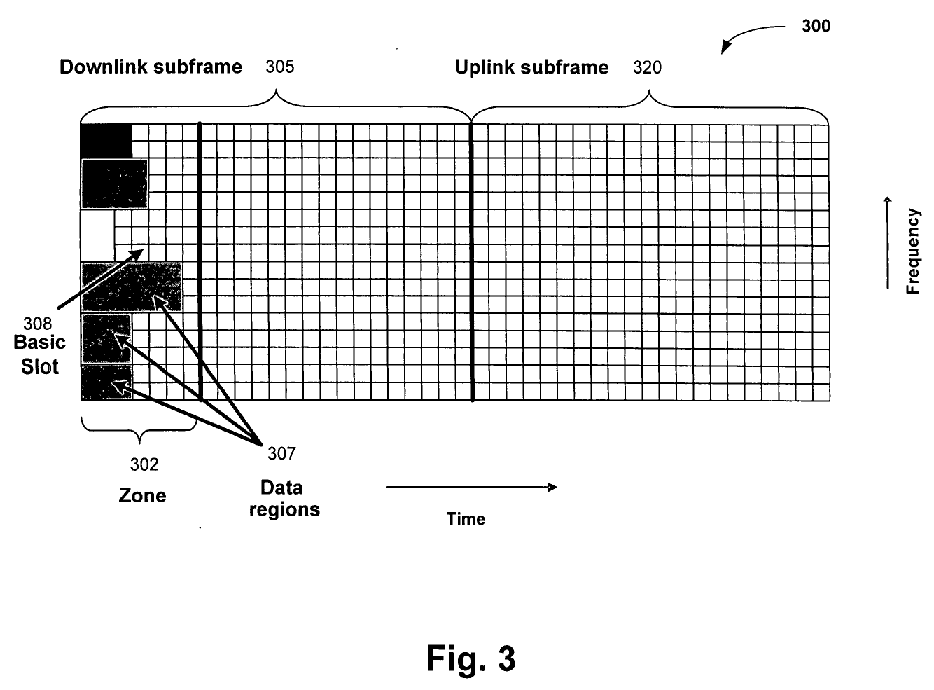

Turning to FIG. 3, for OFDMA, a frame 300 (or subframes 305, 320 if applicable) may be divided into one or more zones 302 each containing an integer number of OFDM symbols. Each zone 302 may be divided into a plurality of data regions 307, which generally (although oversimplified here) are represented by highlighted rectangular regions in time/frequency space as illustrated in FIG. 3.

Each data region 307 may be composed of a plurality of basic slots 308 or elemental units, which are contiguous sequences of modulation symbols (e.g., one subchannel high and one OFDM symbol wide). The exact dimensions of zones 302 and basic slots 308 may be selected based on desired network design and function. Frame assembly therefore means the creation of data regions 307 tiled out of basic slots 308 that are then filled with MAC PDUs or other data structures so that data regions 307 fill as much of the allocated frame (or subframe or zones) as possible. FIGS. 2 & 3 represent airframes for time division duplex (TDD) mode, which include a subframe for downlink and a subframe for uplink but the inventive embodiments are not limited in this respect.

Because MAC PDUs are converted into modulation symbols before they are transmitted in a frame, the number of bits that are used to code the MAC PDU is not the same as the number of bits in the MAC PDU itself. The number of bits used to encode the MAC PDU is referred to as the number of “air bits” of the MAC PDU. Each modulation scheme has a conversion factor that, when multiplied by the number of bits in the MAC PDU, yields the number of air bits required by the MAC PDU.

The problem of filling frames to maximize the amount of data that they carry is an instance of a general mathematical problem called bin packing. The problem with bin-packing is that its computational complexity (the amount of time required to perform it) increases drastically as the amount of data and the number of bins increases. In fact, “exact” bin-packing (where the very best possible bin-packing is sought) is known to be nondeterministic polynomial (NP) complete, which means that the best-known algorithms require time exponential to the amount of data to be packed. Because frame assembly may have strict time constraints on the order of 2-20 milliseconds, exact bin-packing algorithms are not feasible for frame assembly. Further, in frame assembly for wireless communications, bin-packing may have to take into consideration packet scheduling fairness and quality of service (QoS) constraints.

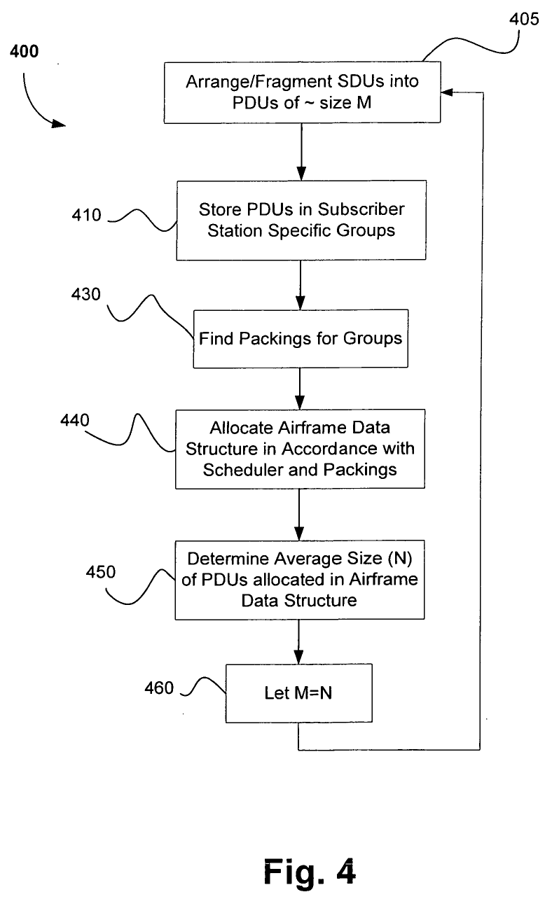

There are a number of conventional approximation algorithms that may be used for bin-packing such as those described in “Approximation Schemes for Multidimensional Packing,” by Jose R. Correa and Claire Kenyon in Proceedings of the 15^{th} Annual ACM-SIAM Symposium on Discrete Algorithms, pp. 186-195 and “A Simple On-Line Bin-Packing Algorithm,” by C. C. Lee and D. T. Lee in The Journal of the ACM, vol. 32, No. 3, Jul. 1985, pp. 562-572. The approximation ratio of these algorithms is in the range of 1.5 to 1.7, meaning that, if an optimal bin-packing algorithm for a particular problem consumes N bins, these algorithms will consume 1.5 N to 1.7 N in a worst case. This translates into the frame being filled to approximately 59-67% of its true capacity. However, turning to FIG. 4, a process 400 which has the ability to dynamically adapt a packet size and to fragment incoming data segments to fill packets to capacity may improve the performance of known bin-packing algorithms.

Method 400 is a method for selecting a group of PDUs to be forwarded to the PHY for modulating into a data region. It is described below in relation to a downlink process, however, a similar algorithm may be used in the uplink process and the inventive embodiments are not limited to any particular direction of data flow. Additionally, method 400 discusses the fragmentation/creation/adaptation of SDUs and/or PDUs but the inventive embodiments are not limited to any specific type of data segment or packet structure.

In one embodiment, method 400 may begin by arranging and, if applicable, fragmenting 405 incoming SDUs into PDUs of roughly size (M) bits. If desired, the PDUs may then be placed 410 in queues based on their associated CID. For each data region, a scheduler 420 visits the set of queues associated with a single data region according to a scheduling algorithm such as Weighted Fair Queuing (WFQ) or Weighted Round Robin (WRR), de-queuing PDUs, until the number of air bits contained in the de-queued PDUs is close to, the number of air bits in the data region divided by the approximation ratio of the bin-packing algorithm of frame assembler 430.

A frame assembler algorithm then performs an approximate bin-packing algorithm to select 430, from the de-queued PDUs, a group of PDUs to be actually included in the air frame. The group of selected PDUs is then forwarded 440 to the PHY to be modulated in the air frame. Any PDUs that may have been de-queued but not selected in the bin-packing process (due to the approximate nature of the bin-packing algorithm) may be stored for the next execution of the algorithm 400 on the data region.

The average size (N) of the PDUs allocated in the frame data structure, potentially, although not required, counting any unallocated slots as “virtual frames,” may be determined 450 and used to adjust 460, e.g., by fragmentation, the size (M) of PDUs formed for subsequent frames. In this manner, the PDUs will tend to change size over time as to more optimally pack into the (sub) frame.

A known bin-packing algorithm may be used to find packings for PDUs with a common subscriber station and an air frame data structure may be constructed by selecting 430 PDUs in a group which can fit in a data region allocated for a particular subscriber station. For example, the group PDUs may be arranged in priority queues based on the results of a bin-packing algorithm results, and the queues may be visited in accordance with a scheduler, for example taking QoS and/or other priorities into consideration. The PDUs may then be de-queued and packed 430 into an air frame data structure until there is no longer a head of line packet which can fit in empty slots of the data region corresponding to that subscriber station. The next priority queue is visited and the remaining data regions may be packed in a similar fashion until the (sub) frame data structure is filled.

In one embodiment, determining 450 the average size (N) of the PDUs allocated in the air frame data structure may include counting unallocated (or empty) slots in the data region as “virtual frames.” For each subscriber station, the number of payload bits corresponding to the average size of the PDUs in air bits may be used to determine the fragmentation size of the next round of PDUs being formed. While various modifications may be made to the implementations, examples, and embodiments described above, dynamic adaptation of packet size (e.g., PDU size) to increase utilization of frame space may provide a significant improvement over static bin-packing processes.

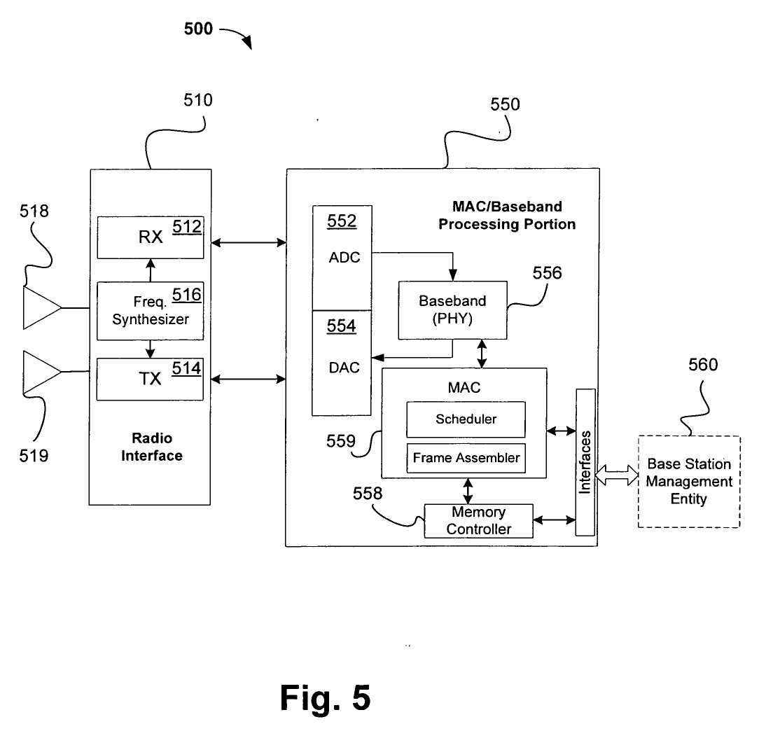

Referring to FIG. 5, an apparatus 500 for use in a wireless network may include a processing circuit 550 adapted to dynamically adjust packet sizes to increase efficient use of the physical frame as described above. In certain embodiments, apparatus 500 may generally include a radio frequency (RF) interface 510 and a baseband and medium access controller (MAC) processor portion 550 although the embodiments are not limited in this respect.

In one example embodiment, RF interface 510 may be any component or combination of components adapted to send and receive multi-carrier modulated signals (e.g., OFDM or OFDMA) although the inventive embodiments are not limited to any particular modulation scheme. RF interface may include a receiver 512, transmitter 514 and frequency synthesizer 516. Interface 510 may also include bias controls, a crystal oscillator and/or one or more antennas 518, 519 if desired. Furthermore, RF interface 510 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description thereof is therefore omitted.

In some embodiments interface 510 may be configured to be compatible with one or more of the Institute of Electrical and Electronics Engineers (IEEE) 802.16 standards specified for broadband wireless networks, although the embodiments are not limited in this respect.

Processing portion 550 may communicate with RF interface 510 to process receive/transmit signals and may include, by way of example only, an analog-to-digital converter 552 for digitizing received signals, a digital to analog converter 554 for analog conversion of transmissions, a baseband processor 556 for physical (PHY) link layer processing of respective receive/transmit signals, and one or more memory controllers 558 for managing read-write operations from one or more internal and/or external memories (not shown). Processing portion 550 may also include or be comprised of a processing circuit 559 for medium access control (MAC)/data link layer processing.

In certain embodiments of the present invention, MAC processing circuit 559 and/or additional circuitry may include a scheduler and/or frame assembler which functions to dynamically adjust packet size and/or pack frames as described previously. MAC processing circuit 559 may also include, if desired, encryption management functions. Alternatively or in addition, baseband processing circuit 556 may share processing for certain of these functions or perform these processes independent of MAC processing circuit 559. MAC and PHY processing may also be integrated into a single component if desired. Apparatus 500 may also include, or interface with, a station management entity 560 which may control or assist in scheduling traffic, quality of service (QoS) attributes and/or other features.

Apparatus 500 may be, for example, a wireless base station, wireless router and/or network adaptor for computing devices. Accordingly, the previously described functions and/or specific configurations of apparatus 500 could be included or omitted as suitably desired.

The components and features of apparatus 500 may be implemented using any combination of discrete circuitry, application specific integrated circuits (ASICs), logic gates and/or single chip architectures. Further, the features of apparatus 500 may be implemented using microcontrollers, programmable logic arrays and/or microprocessors or any combination of the foregoing where suitably appropriate.

It should be appreciated that the example apparatus 500 shown in the block diagram of FIG. 5 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Embodiments of the present invention may be implemented using single input single output (SISO) architectures. However, as shown in FIG. 5, certain preferred implementations may use multiple-input multiple-output (MIMO), MISO, SIMO or other architectures utilizing multiple antennas (e.g., 518, 519) for transmission and/or reception. Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the inventive embodiments.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network, the method comprising:
determining an average size (N) of packets allocated for a particular subscriber station in an air frame; and
adjusting a size (M) of packets for that particular subscriber station to be packed into one or more subsequent air frames to be substantially equal to size (N).

2. The method of claim 1 wherein the packets comprise media access control (MAC) protocol data units (PDUs).

3. The method of claim 1 further comprising arranging incoming data segments and fragmenting one or more of the incoming data segments into the packets of approximately size M.

4. The method of claim 1 further comprising placing the packets into priority queues based upon a connection identification (CID) associated with each packet.

5. The method of claim 4 further comprising de-queuing the packets from the priority queues in accordance with a scheduling algorithm.

6. The method of claim 5 further comprising, for each packet de-queued, determining that packet's size in air bits by finding a burst profile corresponding to the CID and multiplying by the burst profile by a coefficient.

7. The method of claim 6 further comprising employing an approximate bin-packing algorithm to place de-queued packets corresponding to a same subscriber station into a group until a size of air bits for the group of de-queued packets meets an approximation ratio of the approximate bin packing algorithm employed.

8. The method of claim 7 further comprising modulating the grouped packets in an airframe.

9. The method of claim 1 wherein the wireless network comprises a broadband wireless metropolitan area network (WLAN).

10. An apparatus for wireless communications, the apparatus comprising:
a controller circuit configured to fragment incoming data segments into one or more packets to be modulated in an air frame and to dynamically adapt a size of the packets to be modulated in the airframe based on an average size of packets from one or more previous air frames.

11. The apparatus of claim 10 wherein the controller circuit comprises a media access controller (MAC) circuit, wherein the data segments comprise MAC service data units (SDUS) and wherein the packets comprise MAC protocol data units (PDUs).

12. The apparatus of claim 10 wherein the controller circuit comprises a scheduler and a frame assembler.

13. The apparatus of claim 10 further comprising a physical (PHY) circuit to modulate the packets.

14. The apparatus of claim 10 wherein the air frame is one of an orthogonal frequency division multiplexing (OFDM) air frame or an orthogonal frequency division multiple access (OFDMA) air frame.

15. The apparatus of claim 10 wherein the apparatus comprises a base station.

16. A system for wireless communication comprising:
a media access controller (MAC) circuit to fragment incoming data segments into one or more packets to be modulated in an air frame and to dynamically adapt a size of the packets to be modulated in the airframe based on an average size of packets from one or more previous air frames;
a physical (PHY) processing circuit coupled to the MAC circuit to modulate the one or more packets in the airframe; and
at least two antennas coupled to the PHY processing circuit to radiate the airframe as electromagnetic signals.

17. The system of claim 16 wherein the MAC circuit includes a scheduler to select the one or more packets to be modulated and a frame assembler to adapt the size of the packets and organize the packets into the airframe.

18. The system of claim 16 wherein the average size of packets from one or more previous air frames is used to determine how to fragment the incoming data segments.

19. An article of manufacture having stored thereon machine readable instructions that when executed by a processing platform result in:
determining an average size (M) of packets allocated for a particular subscriber station in an air frame; and
adjusting a size of packets for that particular subscriber station to be packed into one or more subsequent air frames to be substantially equal to size M.

20. The article of claim 19 wherein the air frame comprises one of an orthogonal frequency division (OFDM) airframe or an orthogonal frequency division multiple access (OFDMA) airframe.

21. The article of claim 19 further including instructions that when executed by a processing platform result in:
arranging and fragmenting incoming data segments to fill the packets of size (M) to capacity.

22. The article of claim 21 wherein the incoming data segments comprise media access controller (MAC) service data units (SDUs) and wherein the packets comprise MAC protocol data units (PDUs).
